(19) United States
(12) Patent Application Publication
(10) Pub. No.: US 2008/0085754 A1
(43) Pub. Date: Apr. 10, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/783,685

(22) Filed: Apr. 11, 2007

Related U.S. Application Data
(60) Provisional application No. 60/850,260, filed on Oct. 10, 2006.

(51) Int. Cl. A63F 13/00

(52) U.S. Cl. 463/20

(57) ABSTRACT

When a plurality of symbols are arranged on a plurality of defined areas provided in a form of matrix on a display, and the plurality of symbols arranged on the plurality of defined areas are rearranged, at least one of the plurality of defined areas is set as a specific defined area in response to setting input data received from an external. Then, when a symbol relating to a prize is displayed on the set specific defined area as a result of rearranging the plurality of defined symbols arranged on the defined areas, a prize which is doubled of the prize of a case where the symbol relating to the prize is displayed on the defined area other than the set specific defined area is set.

### CROSS REFERENCE TO RELATED APPLICATION

This application claims priority to co-pending U.S. provisional patent application Ser. No. 60/850,260 entitled “SLOT MACHINE AND PLAYING METHOD THEREOF” filed on Oct. 10, 2006 and naming Kazuo OKADA as inventor, and which is incorporated by reference herein for all purposes.

### BACKGROUND OF THE INVENTION

1. Field of the Invention

The present invention relates to a slot machine for playing a game by using a game medium such as a coin and a bill, and to a playing method thereof.

2. Description of the Related Art

As disclosed in U.S. Pat. No. 6,960,133 B1 or U.S. Pat. No. 6,012,983, in the conventional slot machine, when a player inserts a game medium such as a medal, a coin, or a bill into an insertion slot of the slot machine and enters a spin button, a plurality of symbols are scrolled on display portions provided on a front surface of a cabinet, and thereafter, the respective symbols are automatically stopped. At this time, random numbers are generated when the respective symbols start to be scrolled by taking the entering of the spin button as an occasion, and symbols to be rearranged are decided by the random numbers thus generated. Then, when a combination of the rearranged symbols has a display mode corresponding to a predetermined mystery bonus, payout of medals corresponding thereto is executed. When the combination has a display mode showing that a game will be shifted to a second game, the game is shifted from a base game to the second game, and the second game is executed.

Then, the slot machine is adapted to pay out an allotment depending on a winning state generated as the game is advancing.

In the conventional slot machine as described above, only the scrolled symbols are automatically stopped, and a slot machine equipped with a new entertainment factor is desired to come into being.

### SUMMARY OF THE INVENTION

A first aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A second aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize double the prize of a case where the symbol relating to the prize is displayed on the defined area other than the set specific defined area.

A third aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area in response to setting input data received from an external when the symbols are automatically rearranged on all or a part of the defined areas of the display area, displays the specific defined area distinguishably from the other defined areas, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A fourth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which, when the symbols are automatically rearranged on all or a part of the defined areas of the display area, the controller sets at least one of the plurality of defined areas as a specific defined area in response to setting input data received from an external at least before the symbols are rearranged, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A fifth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area for a predetermined number of games in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A sixth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area for a number of games, which is decided randomly, in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A seventh aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area in response to setting input data received from an external when the symbols are automatically rearranged on all or a part of the defined areas of the display area, releases a setting of the specific defined area when a game is not played for a predetermined time, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

An eighth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least one of the plurality of defined areas as a specific defined area in response to setting input data received from an external when the symbols are automatically rearranged on all or a part of the defined areas of the display area, displays the specific defined area distinguishably by color from other defined areas, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A ninth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least some of the plurality of defined areas as a specific defined area group clustered as one block in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

A tenth aspect of the present invention is a slot machine, including: a display having a rectangular display area in which a plurality of defined areas are provided in a form of matrix, and a single symbol is displayed to be arranged or rearranged on each of the defined areas; and a controller for automatically rearranging the symbols on all or a part of the defined areas of the display area, in which the controller sets at least some of the plurality of defined areas as a plurality of specific defined area groups clustered as blocks in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

### BRIEF DESCRIPTION OF THE DRAWINGS

FIG. 1 is a flowchart showing a schematic processing procedure of a playing method of a slot machine according to the present invention.

FIG. 2 is a perspective view showing an exterior appearance of a slot machine according to an embodiment of the present invention.

FIG. 3 is an explanatory view showing symbols to be displayed on rotation reels of the slot machine according to the embodiment of the present invention.

FIG. 4 is an explanatory view showing a payout table for deciding a payout amount of the slot machine according to the embodiment of the present invention.

FIG. 5 is a block diagram showing an internal construction of the slot machine according to the embodiment of the present invention.

FIG. 6 is a flowchart showing a game execution processing executed in the slot machine according to the embodiment of the present invention.

FIG. 7 is a flowchart showing a symbol decision processing executed in the slot machine according to the embodiment of the present invention.

FIG. 8 is a flowchart showing a double-up game processing executed in the slot machine according to the embodiment of the present invention.

FIG. 9 is an explanatory view showing a display example of the slot machine according to the embodiment of the present invention.

FIG. 10 is an explanatory view showing a display example of the slot machine according to the embodiment of the present invention.

FIG. 11 is an explanatory view showing a display example of the slot machine according to the embodiment of the present invention.

FIG. 12 is an explanatory view showing a display area of the slot machine according to the embodiment of the present invention.

### DETAILED DESCRIPTION OF THE INVENTION

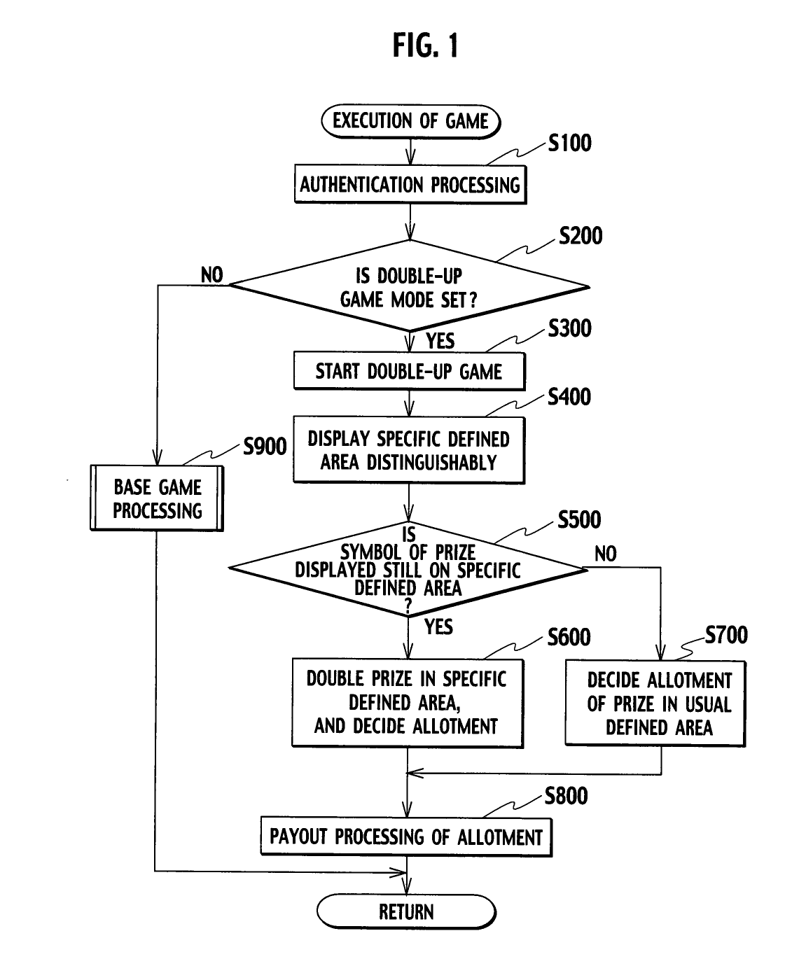

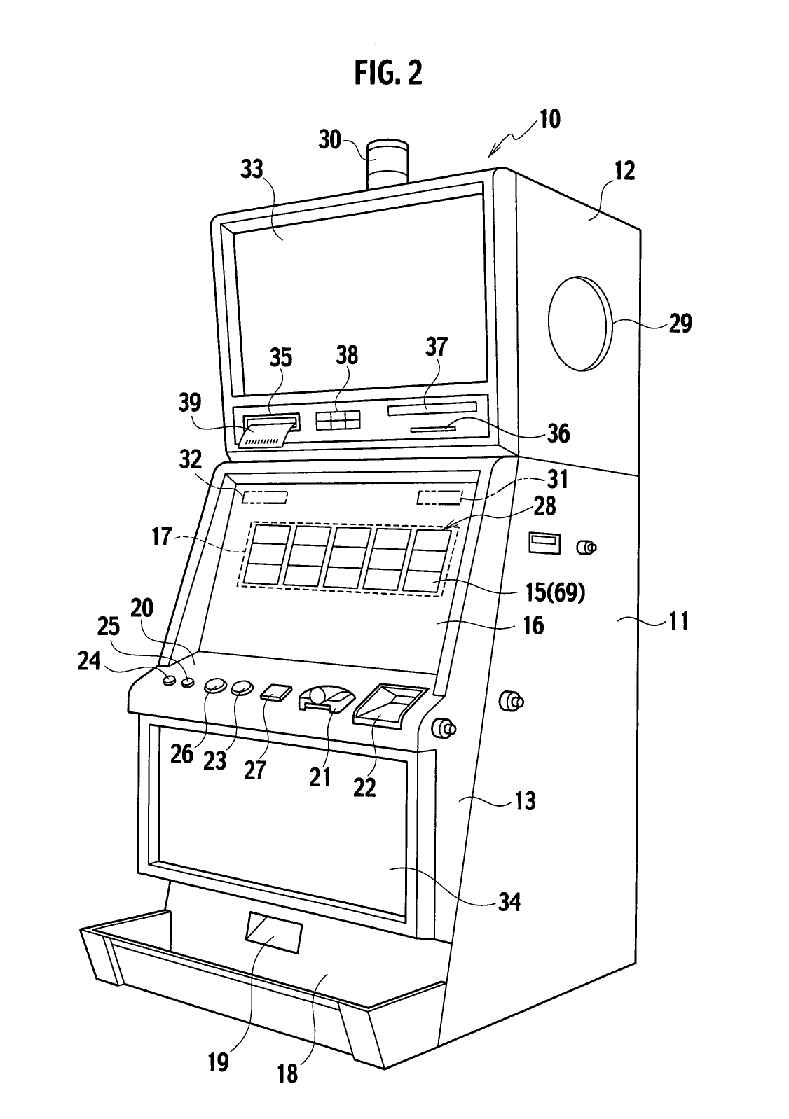

FIG. 1 is a flowchart schematically showing a playing method of a slot machine according to the present invention. A description will be made of schematic operations of the slot machine and the playing method thereof according to the present invention with reference to the flowchart shown in FIG. 1 and a perspective view shown in FIG. 2.

When the slot machine according to the present invention is started by turning on power, an authentication processing is first performed in the slot machine (Step S100). In the authentication processing, there is performed an initial verification processing at a stage before a base game is started, such as to whether a program for operating a system operates normally and whether falsification of the program is not performed.

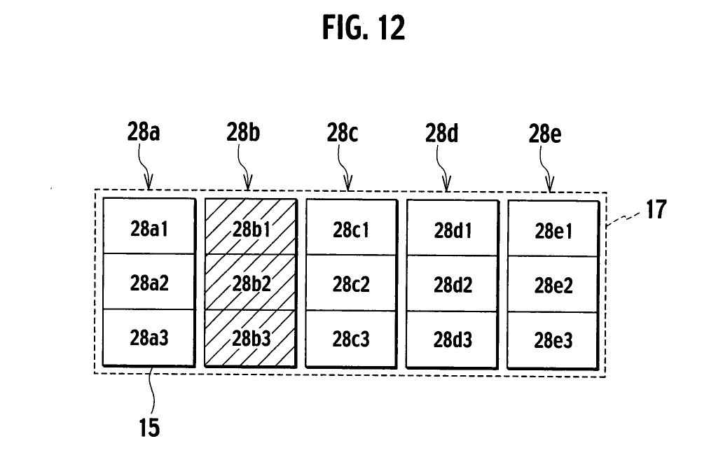

Next, it is determined whether or not a double-up game mode is set by a player (Step S200). The double-up game mode becomes active when specific defined areas are designated by the player. In the double-up game mode, when a symbol relating to a prize is displayed on the specific defined areas, the prize is doubled. Specifically, in an inside of a display window 15 provided on a front surface of a cabinet 11, a display area 28 formed of totally 15 defined areas (28a1 to 28e3) with a matrix of five columns and three rows is provided (refer to FIG. 12). Note that suffixes “a” to “e” assigned to the respective defined areas 28 denote the columns of the respective defined areas 28 provided in the form of matrix, and suffixes “1” to “3” denote the rows thereof.

Moreover, a front surface side of the display window 15 is formed as a touch panel, and in order to designate the specific defined areas, the touch panel is divided, for example, into five columns so as to correspond to the respective defined areas 28. When the player touches any of the five columns of the respective defined areas 28 shown in FIG. 12 at the time when the touch panel is activated, it is sensed that the defined areas 28 of the touched column are the specific defined areas. Here, the description has been made of the touch panel by taking as an example the specific defined areas among those divided into the five columns; however, without being limited to this, the touch panel may be divided into three rows, or may be divided into the respective defined areas.

Note that, though the designation of the specific defined areas by the player is performed before starting the game, the designation may be performed before starting the game and for a period until the symbols are stopped (rearranged) after starting the game.

Next, when the double-up game mode is set, a double-up game is started (Step S300). In the double-up game mode, first, following the designation of the specific defined areas by the player, the specific defined areas thus designated are displayed distinguishably from the other defined areas (Step S400). For example, the designated specific defined areas are displayed in a color different from that of the other defined areas.

Then, when a spin button 23 is pressed in a state where the desired number of credits is bet by inserting a coin into a coin receiving slot 21, and so on, the symbols start to be scrolled on the totally 15 defined areas (28a1 to 28e3) (display areas) with the matrix of five columns and three rows, which are provided in the inside of the display window 15 provided on the front surface of the cabinet 11, and thereafter, the symbols are stopped (rearranged).

Next, it is determined whether or not the symbol relating to the prize is displayed still on the specific defined areas (Step S500). For example, when one column of a defined area group (28a1 to 28a3) on the left side among the five columns of the defined areas is set as the specific defined areas, it is determined that the symbol relating to the prize, for example, a symbol “APPLE” is stopped on any defined area in the defined area group (28a1 to 28a3) on the left side. Note that the setting of the specific defined areas may be made active for the predetermined number of games, or may be made active for the number of game, which is decided randomly. Moreover, when the player does not play the game for a predetermined time, the setting of the specific defined areas may be released.

Next, when the symbol relating to the prize is displayed on the specific defined areas, an allotment to the player is decided in accordance with the symbol relating to the prize, which is displayed still on the specific defined areas, and/or a symbol relating to the prize, which is displayed still on the defined areas (usual defined areas) other than the specific defined areas (Step S600). Specifically, for example, when the symbols relating to the prize are displayed on the specific defined areas and the defined areas (usual defined areas) other than the specific defined areas, there are decided a doubled allotment of the allotment of the prize for the symbol relating to the prize displayed still on the specific defined areas, and decided an allotment of the prize for the symbol relating to the prize displayed still on the defined areas (usual defined areas) other than the specific defined areas. Note that, though the allotment of the prize for the symbol relating to the prize displayed still on the specific defined areas is doubled, the allotment may be increased by a predetermined fixed amount, or on the contrary, the allotment may be decreased.

Note that, when the symbol relating to the prize is displayed only on the defined areas (usual defined areas) other than the specific defined areas, only the allotment of the prize for the symbol concerned is decided (Step S700).

Subsequently, a payout processing for the number of coins in accordance with the allotment decided in the above-described processing is performed (Step S800).

Note that, when the double-up game mode is not set, an usual base game processing is performed (Step S900). Specifically, when the spin button 23 is pressed in the state where the desired number of credits is bet by inserting the coin into the coin receiving slot 21, and so on, the symbols start to be scrolled on the totally 15 defined areas (28a1 to 28e3) with the matrix of five columns and three rows, which are provided in the inside of the display window 15 provided on the front surface of the cabinet 11, and thereafter, the symbols are stopped (rearranged). Then, when the symbol relating to the prize is displayed on the defined areas, the allotment to the player is decided in accordance with the symbol concerned, and the allotment is paid.

In such a way, the play of the slot machine according to the present invention is executed.

Next, a description will be made of a construction of a slot machine 10 according to an embodiment of the present invention with reference to the perspective view shown in FIG. 2. The slot machine 10 is installed in a gaming facility.

In the slot machine 10, a coin, a bill, or electronic valuable information equivalent to these is used as a game medium for executing the base game. However, in the present invention, the game medium is not particularly limited to these, and for example, a medal, a token, electronic money, and a ticket can be mentioned. Note that no particular limitations are imposed on the above-described ticket, and for example, a ticket attached with a bar code, which is as described later, can be mentioned.

As shown in FIG. 2, the slot machine 10 includes the cabinet 11, a top box 12 installed on the cabinet 11, and a main door 13 provided on the front surface of the cabinet 11.

On an upper stage of the cabinet 11, an upper image display panel 33 is provided, and on a middle stage of the cabinet 11, a lower image display panel 16 is provided. Moreover, on a substantial center of the lower image display panel 16, the rectangular display window 15 is provided. In the inside of the display window 15, a liquid crystal display 17 including the display area 28 is provided. The display area 28 is divided into the totally 15 defined areas (28a1 to 28e3) with the matrix of five columns and three rows (refer to FIG. 12). Hence, when the game is executed, the symbols are scrolled on the respective defined areas 28a1 to 28e3 of the liquid crystal display 17, and the player can visually recognize the symbols thus scrolled through the display window 15.

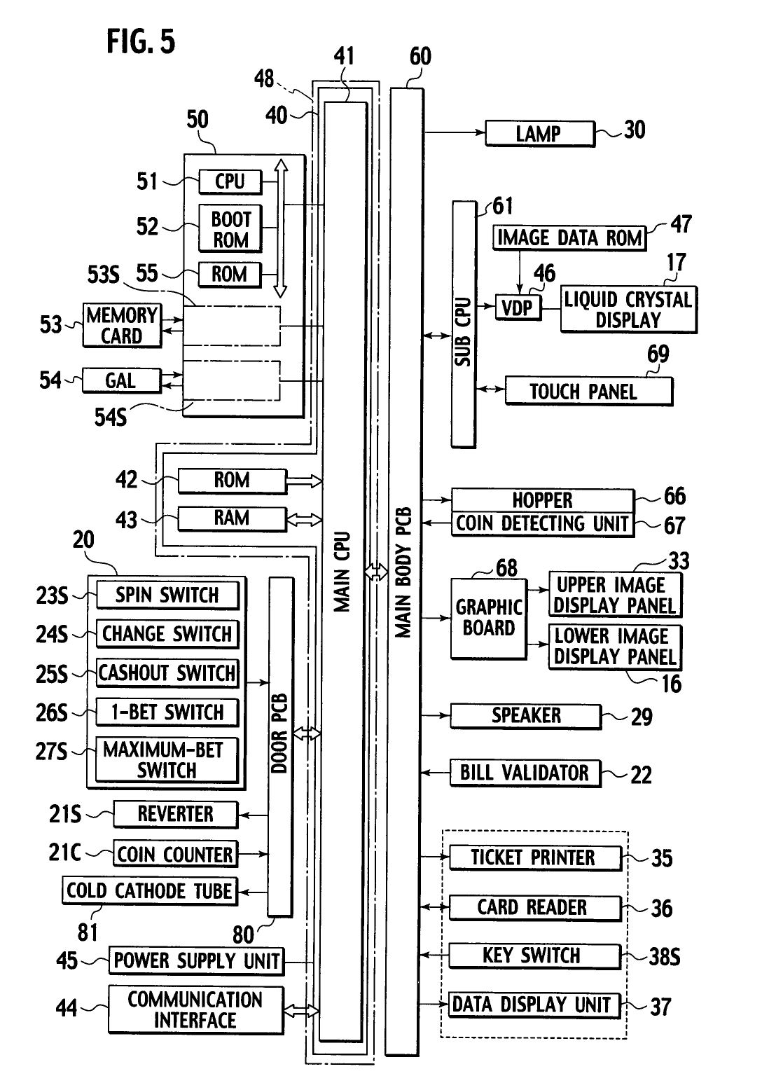

Moreover, on the surface of the display window 15, which is located on a front surface side of the liquid crystal display 17, a touch panel 69 (refer to FIG. 5) is provided so as to correspond to the display area 28. The touch panel 69 is partitioned so as to correspond to the five columns of the respective defined areas 28 (28a1 to 28e3). Specifically, when the touch panel 69 is touched by the player, it becomes possible to identify a touched position for each column of the defined areas 28. Note that the touch panel 69 may be partitioned so as to correspond to the respective defined areas (28a1 to 28e3) of which the number is 15.

Note that, in this embodiment, a description will be made of an example of using, as a display, the liquid crystal display 17 including the display area 28 formed of the defined areas 28 with the matrix of five columns and three rows; however, the defined areas are not limited to the five columns and the three rows.

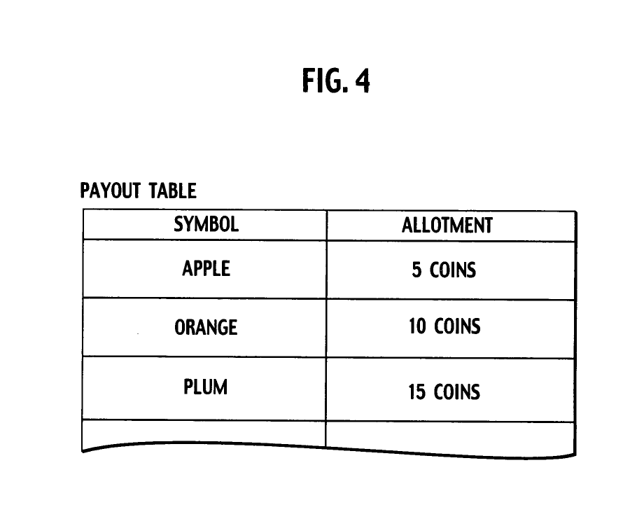

The lower image display panel 16 includes a transparent liquid crystal panel, and during the game, various pieces of information regarding the game, an effect image, and the like are displayed on the transparent liquid crystal panel. On the lower image display panel 16, a number-of-credits display portion 31 and a number-of-payouts display portion 32 are provided. On the number-of-credits display portion 31, the number of credited coins is displayed as an image. On the number-of-payouts display portion 32, each relation between the number of symbols and the number of paid-out coins, which is shown in FIG. 4, is displayed as an image.

Under the lower image display panel 16, there are provided a control panel 20 composed of a plurality of buttons 23 to 27 through which instructions concerned with advancing of the game are entered by the player, the coin receiving slot 21 for receiving the coin into the cabinet 11, and a bill validator 22.

On the control panel 20, there are provided the spin button 23, the change button 24, the cashout button 25, the 1-BET button 26, and the maximum-BET button 27. The spin button 23 is a button for entering an instruction to start the scroll of the respective defined areas (28a1 to 28e3). The change button 24 is a button for use in the case of requesting a clerk at the gaming facility to do a money exchange. The cashout button 25 is a button for entering an instruction to pay out the credited coins to a coin tray 18.

The 1-BET button 26 is a button for entering an instruction to bet one coin among the credited coins on the game. The maximum-BET button 27 is a button for entering an instruction to bet, among the credited coins, on the game, the maximum number (for example, three) of coins capable of being bet on one game.

The bill validator 22 identifies whether or not the bill is a real one, and receives the real bill into the cabinet 11. Note that the bill validator 22 may be composed so as to be capable of reading a ticket 39 attached with the bar code, which will be described later. On a lower front surface of the main door 13, that is, under the control panel 20, belly glass 34 on which a character of the slot machine 10 and the like are drawn is provided.

On a front surface of the top box 12, the upper image display panel 33 is provided. The upper image display panel 33 includes a graphic board 68, and for example, on the upper image display panel 33, the effect image and an image representing an introduction of game contents and an explanation of a game rule are displayed.

Moreover, on the top box 12, a speaker 29 for outputting sounds is provided. Under the upper image display panel 33, there are provided a ticket printer 35, a card reader 36, a data display device 37, and a keypad 38. The ticket printer 35 prints, on a ticket, the bar code in which data regarding the number of credits, date, an identification number of the slot machine 10, and the like is encoded. Then, the ticket printer 35 outputs the printed ticket as such a bar code-attached ticket 39. The player can play a game on another slot machine by using the bar code-attached ticket 39, and can exchange the bar code-attached ticket 39 with bills and the like at a cashier and the like of the gaming facility.

The card reader 36 reads data from a smart card, and writes data to the smart card. The smart card is a card possessed by the player, and stores, for example, data for identifying the player and data regarding a history of the games played by the player.

The data display device 37 is composed of a fluorescent display or the like, and displays, for example, the data read by the card reader 36 and data entered by the player through the keypad 38. The keypad 38 is used for entering an instruction and data regarding issuance of the ticket, and so on.

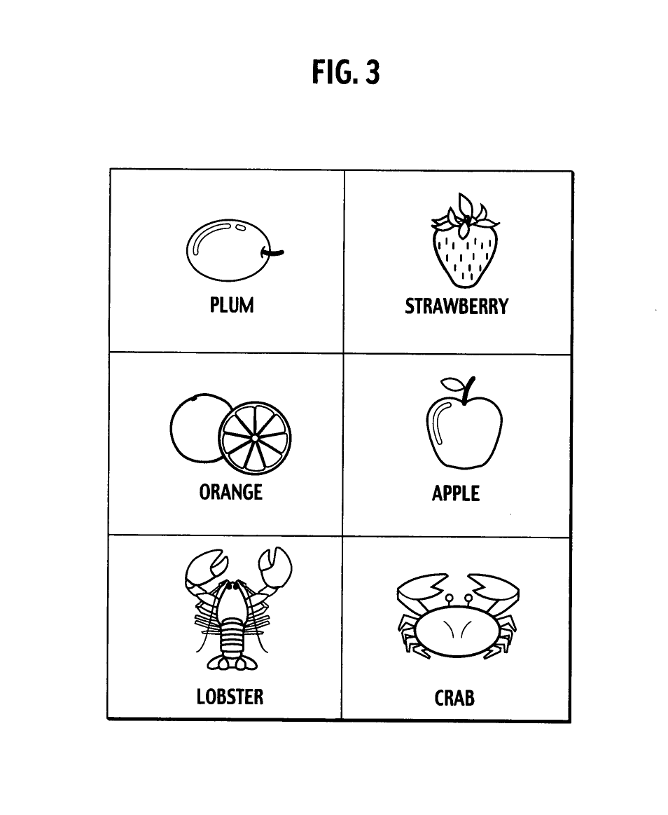

FIG. 3 is an explanatory view showing the symbols to be scrolled on the respective defined areas 28 (28a1 to 28e3) of the liquid crystal display 17 and then displayed still. As shown in FIG. 3, the respective symbols “PLUM”, “ORANGE”, “STRAWBERRY”, “APPLE”, “LOBSTER”, and “CRAB” are to be scrolled.

FIG. 4 is an explanatory view showing a payout table in which the symbols relating to the prizes, which are stopped on the respective defined areas 28 (28a1 to 28e3) in the process of game execution, and the number of coins paid out to the player are set. As shown in FIG. 4, when the symbol “APPLE” is stopped on each of the 15 defined areas 28 (28a1 to 28e3), five coins are paid out.

Moreover, when the symbol “ORANGE” is stopped, ten coins are paid out. Furthermore, when the symbol “PLUM” is stopped, fifteen coins are paid out.

Note that, when the symbol relating to the prize, for example, the symbol “PLUM” is stopped on the specific defined areas designated by the player, the number of paid out coins becomes 30 as a double allotment.

FIG. 5 is a block diagram showing an internal construction of the slot machine shown in FIG. 2. A gaming board 50 includes a CPU (Central Processing Unit) 51, a ROM 55, and a boot ROM 52, which are interconnected by an internal bus, a card slot 53S corresponding to a memory card 53, and an IC socket 54S corresponding to a GAL (Generic Array Logic) 54.

The memory card 53 is composed of a non-volatile memory, and stores a game program. The game program includes a symbol decision program. The symbol decision program is a program for deciding the symbols (code numbers corresponding to the symbols) displayed still on the respective defined areas 28.

Moreover, the card slot 53S is composed so as to be capable of inserting/removing the memory card 53 thereinto/therefrom, and is connected to a motherboard 40 via an IDE bus. Hence, the memory card 53 is removed from the card slot 53S, another game program is written into the memory card 53, and the memory card 53 is inserted into the card slot 53S, thus making it possible to change a type and contents of the game played in the slot machine 10. The game program includes the program concerned with the advancing of the game. Moreover, the game program includes image data and sound data, which are outputted during the game.

The CPU 51, the ROM 55, and the boot ROM 52, which are interconnected via the internal bus, are connected to the motherboard 40 via a PCI bus. The PCI bus transfers a signal between the motherboard 40 and the gaming board 50, and supplies power from the motherboard 40 to the gaming board 50. Moreover, the motherboard 40 and the gaming board 50 construct a controller 48.

The motherboard 40 is composed by using a commercially available general-purpose motherboard (printed wiring board containing basic parts of a personal computer), and includes a main CPU 41, a ROM (Read Only Memory) 42, a RAM (Random Access Memory) 43, and a communication interface 44.

The ROM 42 is formed of a memory device such as a flash memory, and stores a program such as a BIOS (Basic Input/Output System) executed by the main CPU 41, and permanent data. When the BIOS is executed by the main CPU 41, a predetermined initializing processing for peripheral devices is performed, and a capture processing for the game program stored in the memory card 53 through the gaming board 50 is started. Note that, in the present invention, the ROM 42 may be one capable of rewriting the contents thereof, or may be one incapable of such rewriting.

In the RAM 43, data and a program for use when the main CPU 41 operates are stored. Moreover, the RAM 43 can store the game program.

Moreover, in the RAM 43, data regarding the number of credits, the number of inserted game mediums and paid-out game mediums in one game is stored.

Furthermore, to the motherboard 40, there are individually connected a main body PCB (printed circuit board) 60 and a door PCB 80, which will be described later, via USB. Moreover, a power supply unit 45 is connected to the motherboard 40.

To the main body PCB 60 and the door PCB 80, there are connected instruments and devices for generating input signals inputted to the main CPU 41, and instruments and devices, of which actions are controlled by control signals outputted from the main CPU 41. The main CPU 41 executes the game program stored in the RAM 43 based on the input signals inputted to the main CPU 41, thereby performing a predetermined computational processing to store a result thereof in the RAM 43, and transmitting the control signals to the respective instruments and devices for the purpose of a control processing for the respective instruments and devices.

To the main body PCB 60, there are connected a lamp 30, a sub CPU 61, a hopper 66, a coin detection unit 67, the graphic board 68, the speaker 29, the bill validator 22, the ticket printer 35, the card reader 36, a key switch 38S, and the data display device 37. The lamp 30 turns on in a predetermined pattern based on the control signal outputted from the main CPU 41.

The sub CPU 61 is connected to a VDP (Video Display Processor) 46 and the touch panel 69.

The touch panel 69 is provided on the surface of the display window 15 shown in FIG. 2, and in the case where the player touches the touch panel 69 when the touch panel 69 is activated, the touch panel 69 senses the touched position. Specifically, the player touches the touch panel 69 on a position corresponding to the five columns of the defined areas 28 (28a1 to 28e3), thus making it possible to select, as the specific defined areas, an arbitrary column among the respective defined areas 28.

The VDP 46 reads out image data of the symbols, which are stored in an image data ROM 47, generates images to be displayed on the respective defined areas 28 (28a1 to 28e3) of the liquid crystal display 17, and outputs the image data to the liquid crystal display 17. Here, the image data is generated so that the specific defined areas selected through the touch panel 69 can be displayed in a color different from that of the other defined areas. Specifically, based on a position sensing signal from the touch panel 69, the sub CPU 61 instructs the VDP 46 to generate the image data in which the specific defined areas selected through the touch panel 69 are displayed in a color different from that of the other defined areas.

The hopper 66 is installed in the cabinet 11, and pays out a predetermined number of coins from a coin payout opening 19 to the coin tray 18 based on the control signal outputted from the main CPU 41. The coin detection unit 67 is provided in an inside of the coin payout opening 19, and when detecting that the predetermined number of coins are paid out from the coin payout opening 19, outputs an input signal to the main CPU 41.

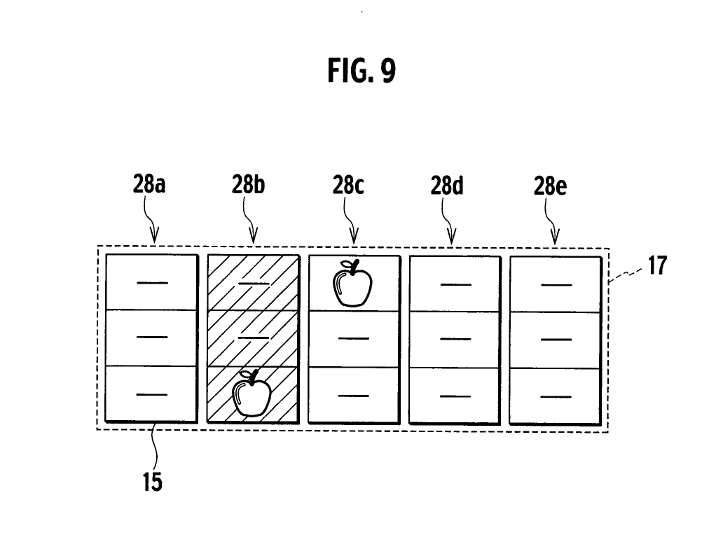

The graphic board 68 controls displays of images on the upper image display panel 33 and the lower image display panel 16 based on the control signal outputted from the main CPU 41. On the number-of-credits display portion 31 of the lower image display panel 16, the number of credits, which is stored in the RAM 43, is displayed. Moreover, on the number-of-payouts display portion 32 of the lower image display panel 16, the number of paid-out coins is displayed. Furthermore, when a bonus game is executed, a number-of-counts display portion 92 shown in FIG. 9 is displayed on the upper image display panel 33.

The graphic board 68 includes a VDP (Video Display Processor) for generating image data based on the control signal outputted from the main CPU 41, a video RAM for temporarily storing the image data generated by the VDP, and the like. Note that the image data for use in the case of generating the image data by the VDP is included in the game program read from the memory card 53 and stored in the RAM 43.

The bill validator 22 identifies whether or not the bill is a real one, and receives a real bill in the cabinet 11. Upon receiving the real bill, the bill validator 22 outputs an input signal to the main CPU 41 based on an amount of the received bill. The main CPU 41 stores, in the RAM 43, the number of credits, which corresponds to the amount of the bill, the amount being transmitted by the input signal.

Based on the control signal outputted from the main CPU 41, the ticket printer 35 prints, on the ticket, the bar code in which the data regarding the number of credits, the date, the identification number of the slot machine 10, and the like, which are stored in the RAM 43, is encoded. Then, the ticket printer 35 outputs the printed ticket as the bar code-attached ticket 39. The card reader 36 reads the data from the smart card, and then transmits the read data to the main CPU 41. Moreover, the card reader 36 writes the data to the smart card based on the control signal from the main CPU 41. The key switch 38S is provided on the keypad 38, and outputs a predetermined input signal to the main CPU 41 when the keypad 38 is operated by the player. Based on the control signal outputted from the main CPU 41, the data display device 37 displays the data read by the card reader 36 and the data entered by the player through the keypad 38.

To the door PCB 80, there are connected the control panel 20, a reverter 21S, a coin counter 21C, and a cold cathode tube 81. On the control panel 20, there are provided a spin switch 23S corresponding to the spin button 23, a change switch 24S corresponding to the change button 24, a cashout switch 25S corresponding to the cashout button 25, a 1-BET switch 26S corresponding to the 1-BET button 26, and a maximum-BET switch 27S corresponding to the maximum-BET button 27. The respective switches 23S to 27S output input signals to the main CPU 41 when the buttons 23 to 27 corresponding thereto are operated by the player.

The coin counter 21C is provided in an inside of the coin receiving slot 21, and identifies whether or not the coins inserted into the coin receiving slot 21 by the player are real ones. Coins other than the real coins are discharged from the coin payout opening 19. Moreover, upon detecting the real coins, the coin counter 21C outputs an input signal to the main CPU 41.

The reverter 21S operates based on the control signal outputted from the main CPU 41, and distributes the coins recognized as the real coins by the coin counter 21C to a cash box (not shown) installed in an inside of the slot machine 10 or to the hopper 66. Specifically, when the hopper 66 is filled with the coins, the real coins are distributed to the cash box by the reverter 21S. Meanwhile, when the hopper 66 is not filled with the coins, the real coins are distributed to the hopper 66. The cold cathode tube 81 functions as a backlight installed on backsides of the lower image display panel 16 and the upper image display panel 33, and is turned on based on the control signal outputted from the main CPU 41.

Next, a description will be made of the processing executed in the slot machine 10. The main CPU 41 reads out and executes the game program, thereby advancing the game.

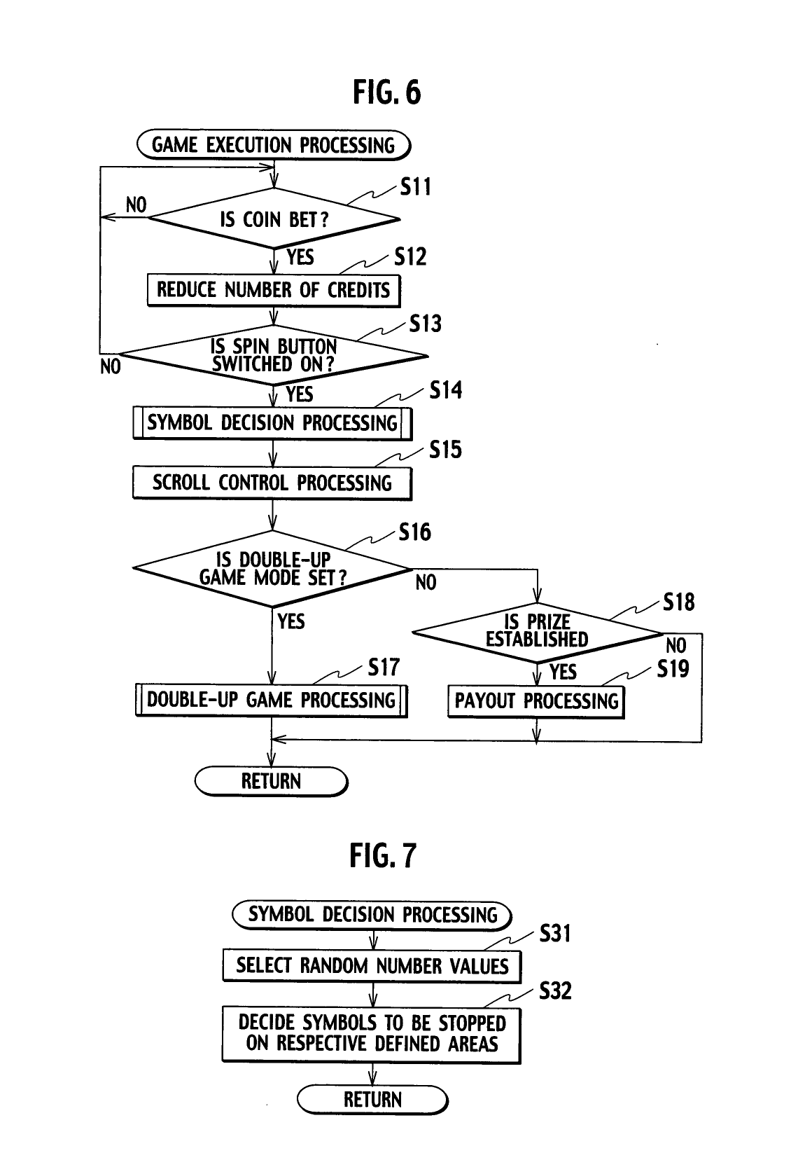

FIG. 6 is a flowchart showing a game execution processing. In the game execution processing, first, the main CPU 41 determines whether or not the coin is bet (Step S11). In this processing, the main CPU 41 determines whether or not to have received the input signal outputted from the 1-BET switch 26S when the 1-BET button 26 is operated or the input signal outputted from the maximum-BET switch 27S when the maximum-BET button 27 is operated. In the case of determining that the coin is not bet, the main CPU 41 returns the processing to Step S11.

Meanwhile, in the case of determining that the coin is bet in Step S11, the main CPU 41 performs a processing for reducing the number of credits, which is stored in the RAM 43, in response to the number of bet coins (Step S12). Note that, when the number of bet coins is larger than the number of credits, which is stored in the RAM 43, the main CPU 41 returns the processing to Step S11 without performing the processing for reducing the number of credits, which is stored in the RAM 43. Meanwhile, when the number of bet coins exceeds an upper limit value (for example, three) of the number capable of being bet on one game, the main CPU 41 moves the processing to Step S13 without performing the processing for reducing the number of credits, which is stored in the RAM 43.

In Step S13, the main CPU 41 determines whether or not the spin button 23 is switched on. In this processing, the main CPU 41 determines whether or not to have received the input signal outputted from the spin switch 23S when the spin button 23 is pressed.

In the case of determining that the spin button 23S is not switched on, the processing is returned to Step S10. Note that, when the spin button 23 is not switched on (for example, when an instruction telling that the game will be ended is entered without switching on the spin button 23), the main CPU 41 cancels a result of the reduction in Step S12.

Meanwhile, in the case of determining in Step S13 that the spin button 23 is switched on, the main CPU 41 performs a symbol decision processing (Step S14). In this symbol decision processing, the main CPU 41 executes the symbol decision program stored in the RAM 43, thereby deciding the code numbers at the time when the symbols are stopped. This processing will be described later in detail by using FIG. 7. Note that, in this embodiment, a description will be made of the case where one or plural prizes are decided from the plural types of prizes by deciding the symbols to be displayed still; however, in the present invention, for example, the one or plural prizes selected from the plural types of prizes may be decided, and thereafter, a combination of the symbols to be displayed still may be decided based on the above-described prizes.

Next, the main CPU 41 performs a scroll control processing for the respective defined areas 28 (28a1 to 28e3) of the liquid crystal display 17 (Step S15). This processing is a processing for display control so that the symbols decided in Step S14 can be displayed still after the symbols start to be scrolled.

Next, the main CPU 41 determines whether or not the double-up game mode is set by the player before the symbols decided in Step S14 are displayed still (Step S16). Specifically, the main CPU 41 determines whether or not the player touches any of the five columns of the defined areas 28 shown in FIG. 12 and the touched column of the defined areas 28 is sensed as the specific defined areas.

Here, the description has been made of the touch panel by taking as an example the specific defined areas among those divided into the five columns; however, without being limited to this, the touch panel may be divided into the three rows, or may be divided into the respective defined areas.

Note that, here, with regard to the designation of the specific defined areas by the player, the description has been made of the embodiment of the case where the designation is performed before starting the game after the end of the previous game and for the period until the symbols are stopped (rearranged) after starting the game; however, the designation may be performed until the game is started after the end of the previous game.

Moreover, the setting of the specific defined areas may be made active for the predetermined number of games (for example, three games), or may be made active for the number of games, which is decided randomly. Furthermore, when the player does not play the game for the predetermined time (for example, 20 minutes), the setting of the specific defined areas may be released.

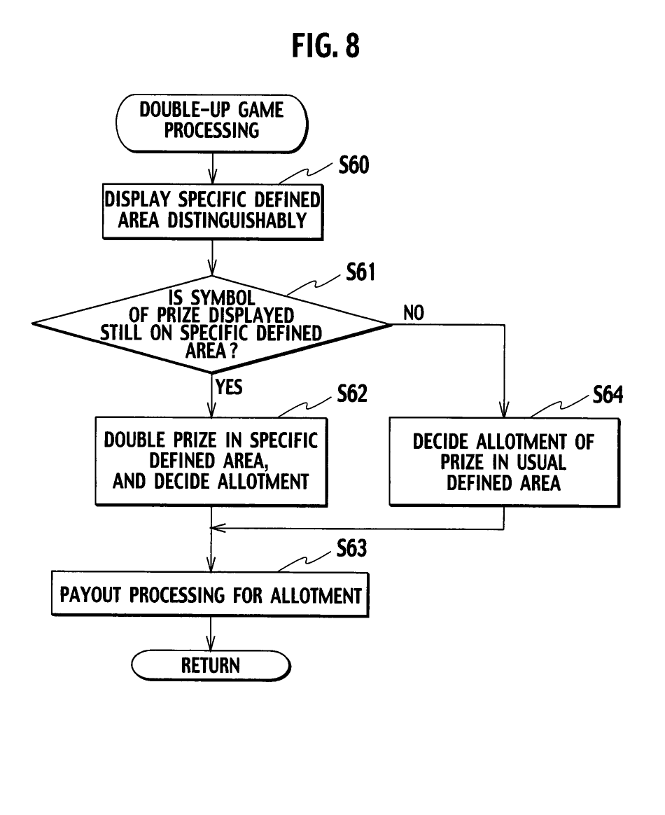

In the case of determining that the double-up game is set, the main CPU 41 reads out the program for playing the double-up game from the RAM 43, executes a double-up game processing (Step S17), and ends this subroutine. A description will be made later in detail of the double-up game processing by using FIG. 8.

In the case of determining that the double-up game is not set (NO in Step S16), the main CPU 41 recognizes the current game as the base game, and determines whether or not the prize is established (Step S18). The establishment of the prize is decided by the symbol relating to the prize stopped on the defined areas 28 (28a1 to 28a3). For example, as shown in FIG. 4, when one symbol “ORANGE” is stopped as the symbol relating to the prize, payout of ten coins occurs.

Then, the main CPU 41 performs the payout processing (Step S19), and ends this subroutine. Meanwhile, when the prize is not established (NO in Step S18), the main CPU 41 ends this subroutine.

FIG. 7 is a flowchart showing the subroutine of the stopped symbol decision processing executed in Step S14 of FIG. 6. This processing is a processing performed in such a manner that the main CPU 41 executes the symbol decision program stored in the RAM 43.

First, the main CPU 41 executes a random number generating program included in the symbol decision program, and thereby selects random number values individually corresponding to the respective symbols from a numerical range of 0 to 255 (Step S31). In this embodiment, a description will be made of the case of generating the random numbers on the program (the case of using so-called software random numbers). However, in the present invention, a random number generator may be provided in advance, and the random numbers may be sampled from the random number generator (so-called hardware random numbers may be used).

Next, the main CPU 41 decides the symbols to be stopped on the respective defined areas 28 (28a1 to 28e3) based on the selected random number values (Step S32).

FIG. 8 is a flowchart showing a subroutine of the double-up game processing executed in Step S17 shown in FIG. 6. In the double-up game processing, first, at the same time when the specific defined areas is designated by the player, the main CPU 41 displays the specific defined areas thus designated distinguishably from the other defined areas (Step S60). For example, as shown in FIG. 12, when a column of the defined areas (28b1 to 28b3) is designated as the specific defined areas, the designated specific defined areas are displayed in a color different from that of the other defined areas. In FIG. 12, the display of the different color is expressed by oblique lines. In such a way, the specific defined area group and the other defined area groups are distinguished from each other, and the player is notified which of the defined area groups is selected as the specific defined area group.

Next, the main CPU 41 determines whether or not the symbol relating to the prize is displayed still on the specific defined areas (Step S61). For example, as shown in FIG. 12, when the defined area group (28b1 to 28b3) is set as the specific defined areas among the five columns of the defines areas, it is determined that the symbol (refer to FIG. 4) relating to the prize is stopped on any defined area of the defined area group (28b1 to 28b3) concerned, and so on.

Next, when the symbol relating to the prize is displayed on the specific defined areas, the main CPU 41 decides the allotment to the player in accordance with the symbol relating to the prize, which is displayed still on the specific defined areas, and with the symbol relating to the prize, which is displayed still on the defined areas (usual defined areas) other than the specific defined areas (Step S62).

Specifically, for example, as shown in FIG. 9, when “APPLE” as the symbol relating to the prize is displayed on the defined area 28b3 among the specific defined area group (28b1 to 28b3) and on the defined area (usual defined area) 28c1 other than the specific defined area group (28b1 to 28b3), there are decided ten coins as the allotment doubled of five coins as the allotment of the prize for the symbol “APPLE” displayed still on the defined area 28b3, and five coins as the allotment of the prize for the symbol “APPLE” displayed still on the defined area 28c1 other than the specific defined area group (28b1 to 28b3), and the allotment becomes 15 coins in total.

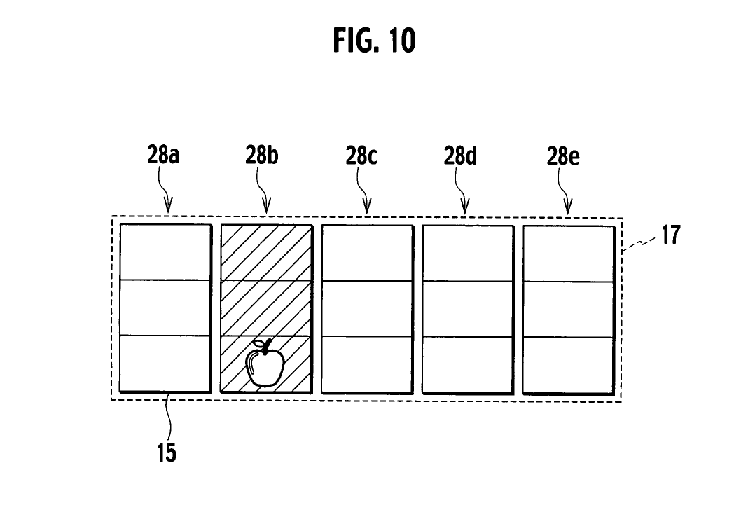

Moreover, for example, as shown in FIG. 10, when “APPLE” as the symbol relating to the prize is displayed on the defined area 28b3 among the specific defined area group (28b1 to 28b3), and the symbol relating to the prize is not displayed on the defined area (usual defined area) other than the specific defined area group (28b1 to 28b3), the allotment of ten coins as a double of the five coins as the allotment of the prize for the symbol “APPLE” is decided.

Note that, when the symbol relating to the prize is displayed only on the defined area (usual defined area) other than the specific defined area group (28b1 to 28b3) (NO in Step S61), only the allotment of the prize for the symbol concerned is decided (Step S64).

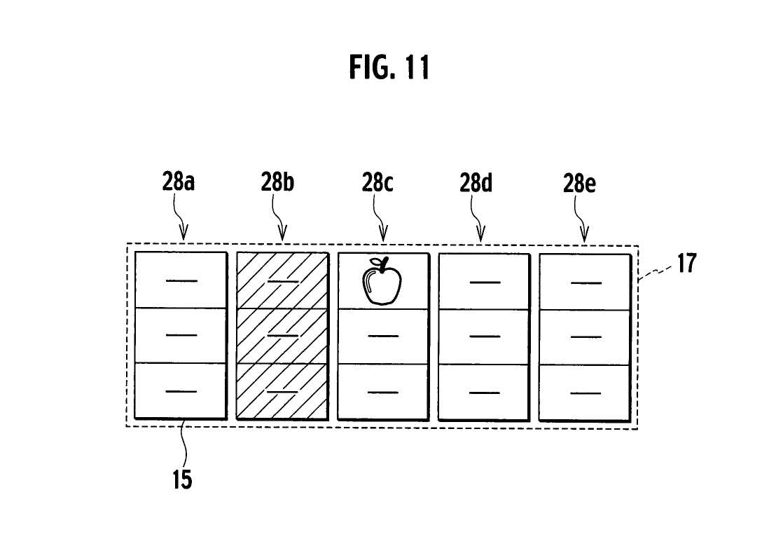

Specifically, for example, as shown in FIG. 11, when “APPLE” as the symbol relating to the prize is displayed only on the defined area (usual defined area) 28c1 other than the specific defined area group (28b1 to 28b3), the five coins as the allotment of the prize for the symbol “APPLE” displayed still on the defined area 28c1 other than the specific defined area group (28b1 to 28b3) is decided.

Subsequently, the main CPU 41 performs the payout processing for the number of coins in accordance with the allotment decided in the above-described processing (Step S63). For example, as shown in FIG. 9, when “APPLE” as the symbol relating to the prize is displayed on 28b3 among the specified defined area group (28b1 to 28b3) and the defined area (usual defined area) 28c1 other than the specific defined area group (28b1 to 28b3), 15 coins are paid out.

As described above, in the slot machine according to this embodiment, when the plurality of symbols are arranged on the plurality of defined areas provided in the form of matrix on the display, and the plurality of symbols arranged on the plurality of defined areas are rearranged, at least one column of the plurality of defined areas is set as the specific defined areas in response to setting input data received from an external. Then, when the symbol relating to the prize is displayed on the specific defined areas thus set as a result of rearranging the plurality of symbols arranged on the defined areas, the prize which is doubled of the prize of the case where the symbol relating to the prize is displayed on the defined areas other than the set specific defined areas is set.

Hence, new fun to set the specific defined areas is given to the player, and a new expectation as to whether or not the symbol relating to the prize is displayed still on the specific defined areas is given thereto, thus making it possible to prevent the player from losing interest in the game.

Moreover, when the player sets the specific defined areas by him/herself, and the symbol relating to the prize is displayed still on these defined areas, more coins are paid out. Accordingly, satisfaction that the selection made by him/herself has been appropriate can be given to the player.

Moreover, the specific defined areas are set for the predetermined number of games, and accordingly, the player makes an attempt to display the symbol relating to the prize still on the specific defined areas during the predetermined number of games, and the interest in the game can be increased.

Moreover, the specific defined areas are set for the number of games, which is decided randomly, and accordingly, the player makes an attempt to display the symbol relating to the prize still on the specific defined areas during the decided number of games, and the interest in the game can be increased.

Furthermore, in the above-described embodiment, the description has been made of the example where the player sets the arbitrary defined area group as the specific defined area group among the respective defined area groups divided into the five columns; however, the specific defined area group may be decided randomly by the control of the main CPU 41. Moreover, the defined area group that is always the same may be set as the specific area group.

Moreover, in this embodiment and a modification example, the description has been made of the example of using the liquid crystal display 17 as the display; it is also possible to use other displays such as a CRT and a plasma display in place of the liquid crystal display 17.

The description has been made above of the slot machine and the playing method of the slot machine according to the present invention based on the illustrated embodiment. However, the present invention is not limited to this, and the constructions of the respective units can be replaced by arbitrary constructions having similar functions.

The description has been made above of the embodiment of the slot machine according to the present invention; however, the embodiment merely illustrates a specific example, and does not particularly limit the preset invention. It is possible to appropriately change designs of specific constructions of the respective means and the like. Moreover, the effects described in the embodiment of the present invention merely list the most preferable effects resulting from the present invention, and the effects from the present invention are not limited to those described in the embodiment of the present invention.

What is claimed is:

1. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

2. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize double the prize of a case where the symbol relating to the prize is displayed on the defined area other than the set specific defined area.

3. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area in response to setting input data received from an external when the symbols are automatically rearranged on all or a part of the defined areas of the display area, displays the specific defined area distinguishably from the other defined areas, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

4. A slot machine comprising:
a display that includes a rectangular display area in which a plurality of defined areas are provided in a form of matrix, and a single symbol is displayed to be arranged or rearranged on each of the defined areas; and
a controller that, when the symbols are automatically rearranged on all or a part of the defined areas of the display area, sets at least one of the plurality of defined areas as a specific defined area in response to setting input data received from an external at least before the symbols are rearranged, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

5. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area for a predetermined number of games in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

6. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area for a number of games, which is decided randomly, in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

7. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area in response to setting input data received from an external when the symbols are automatically rearranged on all or a part of the defined areas of the display area, releases a setting of the specific defined area when a game is not played for a predetermined time, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

8. A slot machine comprising:
a display that includes a rectangular display area in which a plurality of defined areas are provided in a form of matrix, and a single symbol is displayed to be arranged or rearranged on each of the defined areas; and
a controller that sets at least one of the plurality of defined areas as a specific defined area in response to setting input data received from an external when the symbols are automatically rearranged on all or a part of the defined areas of the display area, displays the specific defined area distinguishably by color from other defined areas, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

9. A slot machine comprising:
a display that includes a rectangular display area in which a plurality of defined areas are provided in a form of matrix, and a single symbol is displayed to be arranged or rearranged on each of the defined areas; and
a controller that sets at least some of the plurality of defined areas as a specific defined area group clustered as one block in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

10. A slot machine comprising:
a display that includes a rectangular display area in which a plurality of defined areas are provided in a form of matrix, and a single symbol is displayed to be arranged or rearranged on each of the defined areas; and
a controller that sets at least some of the plurality of defined areas as a plurality of specific defined area groups clustered as blocks in response to setting input data received from an external when the symbols are automatically rearranged on all or a part of the defined areas of the display area, and when a symbol relating to a prize is displayed on the set specific defined area as a result of rearranging a plurality of the symbols arranged on the defined areas, sets a prize different from the prize of a case where the symbol relating to the prize is displayed on the defined area other than the set specific defined area.

11. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

12. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external, when the symbols are automatically rearranged on all or a part of the defined areas; and
setting a prize double a prize of a case where a symbol relating to a prize is displayed on the defined area other than the set specific defined area, when the symbol relating to the prize is displayed on the set specific defined area as a result of rearranging the plurality of symbols arranged on the defined areas.

13. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external and displaying the specific defined area distinguishably from the other defined areas, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

14. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external at least before the symbols are rearranged, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

15. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area for a predetermined number of games in response to setting input data received from an external when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

16. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area for a number of games, which is decided randomly, in response to setting input data received from an external when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

17. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external when the symbols are automatically rearranged on all or a part of the defined areas, and releasing a setting of the specific defined area when a game is not played for a predetermined time; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

18. A playing method executed in a slot machine comprising the steps of:
deciding a plurality of symbols to be rearranged by a controller before a plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least one of the plurality of defined areas as a specific defined area in response to setting input data received from an external and displaying the specific defined area distinguishably by color from other defined areas, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

19. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least some of the plurality of defined areas as a specific defined area group clustered as one block in response to setting input data received from an external, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.

20. A playing method executed in a slot machine comprising the steps of:
deciding a plurality of symbols to be rearranged by a controller before the plurality of symbols are rearranged and rearranging a combination of the plurality of symbols on a plurality of defined areas, when the plurality of symbols are arranged on the plurality of defined areas provided in a form of matrix on a display and the plurality of symbols arranged on the plurality of defined areas are rearranged;
setting at least some of the plurality of defined areas as a plurality of specific defined area groups clustered as blocks in response to setting input data received from an external, when the symbols are automatically rearranged on all or a part of the defined areas; and
setting a prize different from a prize of a case where a symbol relating to a prize is displayed on the defined area other than the set specific defined area, when the symbol relating to the prize is displayed on the set specific defined area as a result of rearranging the plurality of symbols arranged on the defined areas.
